(19) United States
(12) Patent Application Publication
(10) Pub. No.: US 2017/0116622 A1
(43) Pub. Date: Apr. 27, 2017

(54) SYSTEM AND METHOD FOR EVENT MARKETING MEASUREMENT

(71) Applicant: SPARKS EXHIBITS HOLDING CORPORATION, Philadelphia, PA (US)

(72) Inventor: Dax Callner, New York, NY (US)

(73) Assignee: SPARKS EXHIBITS HOLDING CORPORATION, Philadelphia, PA (US)

(21) Appl. No.: 14/924,183

(22) Filed: Oct. 27, 2015

(51) Int. Cl. G06Q 30/02

(52) U.S. Cl. CPC G06Q 30/0202

(57) ABSTRACT

The present system and method include a measurement system for experiential activations. The system and method include consistent, multi-faceted metrics and measurements across all events. This allows for an efficient and comprehensive measure of event impact, development of normative data over time to create benchmarks for metrics, direct comparison of events to other events, and a scalable and flexible measurement program that is able to handle large and small events and all events in between.

### FIELD OF INVENTION

The present invention is related to a system and method for measuring event marketing.

### BACKGROUND

A great deal of money and time is being spent on events for marketing and advertising purposes. Quantifying the value derived from hosting an event or participating as a paid sponsor in a hosted event can be difficult. People improvise by counting the foot traffic through an event experience, or past a company's display. The number of badges scanned can also be used to metricize the success of an event. Or, the event producer may attempt to rank the quality of attendees impacted. As with other marketing channels, the event marketing industry has long been challenged with a comprehensive and accurate methodology for evaluating the impact of event marketing investments.

A first reason to measure event marketing is to protect or grow the budget for the marketing. Without evidence of effectiveness, defending budgets and/or asking for additional funding is difficult.

A second reason to measure event marketing is to improve results. Without data indicating what is working and what is not, improvement is difficult.

The present invention provides solutions to these problems and provides event marketers with measurements to protect/grow their budget and improve results.

### SUMMARY

The present system and method includes a measurement system for event marketing activations. The system and method includes consistent metrics and measurements across all events. This allows for an efficient evaluation of event impact, the ability to develop normative data over time to create benchmarks for metrics, to directly compare events to other events, and to provide a scalable and flexible measurement program that is able to handle large and small events and all event marketing experiences in between.

A system and method for event marketing measurement is disclosed. The system includes a data input module configured to receive information about an event from visitors of the event, and an enterprise system. The enterprise system includes a communication interface configured to receive the information from the data input module, a memory device to configured to store the information received by the communication interface, and a processor to derive metrics from the stored information associated with the event, the metrics including an opportunity score, a brand score, a relationship impact score, and an experience score, the metrics being combined to determine an overall event score. The overall event score may be a combination using equal weighting of the metrics. The overall event score may be a combination using unequal weighting of the metrics.

The system may also include the communication interface outputting the overall event score via email to a distribution list. The system may also include the communication interface receiving overall event scores from other events and the processor comparing the overall event score with the received overall event scores of other events. The received information received by the data input module may include at least a plurality of on-site personal intercept surveys, online surveys, inquiry/lead analysis.

The metrics are derived individually using an average score on the questions determined to be identified with one or more of the metrics. The metrics may be derived based on revenue potential.

The method for performing event marketing measurement includes receiving, at a data input module, information about an event from visitors of the event, receiving, via a communication interface of an enterprise system, the information from the data input module, storing, via a memory device of the enterprise system, the information received by the communication interface, and deriving, using a processor of the enterprise system, metrics from the stored information associated with the event, the metrics including an opportunity score, a brand score, a relationship impact score, and an experience score, the metrics being combined to determine an overall event score. The overall event score is a combination using equal weighting of the metrics, or may be a combination using unequal weighting of the metrics. The opportunity score measures the potential sales opportunities for products or services marketed at the event. The brand score measures the impact of the event on brand perceptions. The relationship impact score measures the quality of relationships as a result of the event. The experience score measures the quality of the experience based on the event.

The method may further include outputting, via a communications interface of the enterprise system, the overall event score via email to a distribution list. The method may further include receiving, via a communications interface of the enterprise system, overall event scores from other events and comparing, using the processor of the enterprise system, the overall event score with the received overall event scores of other events.

The information received by the data input module includes at least a plurality of on-site personal intercept surveys, online surveys, inquiry/lead analysis. The metrics are derived individually using an average score on the questions determined to be identified with one or more of the metrics. The metrics may be derived based on revenue potential.

### BRIEF DESCRIPTION OF THE DRAWINGS

A more detailed understanding may be had from the following description, given by way of example in conjunction with the accompanying drawings wherein:

FIG. 1 illustrates a system for event measurement;

FIG. 2 illustrates a method for event measurement;

FIG. 3 illustrates the four areas of performance utilized in the system of FIG. 1;

FIGS. 4A and 4B illustrate a screen shot of the calculation of the total event score, the weighted score, and the individual scores including opportunity score, a brand score, a relationship impact score, and an experience score;

FIG. 4C illustrates a summary presentation of the scores;

FIG. 5 shows an example computing device that may be used to implement features describe above with reference to FIGS. 1-4; and

FIG. 6 shows a tablet computer that is a more specific example of the computing device of FIG. 5.

### DETAILED DESCRIPTION OF THE PREFERRED EMBODIMENT(S)

The present system and method ties event metrics to business value. This connection allows companies to effectively measure the impact of their events as contributors to larger sales, marketing and customer service efforts. The system and method utilize current marketing industry metrics to provide a consistent approach to the holistic assessment of event effectiveness.

For purposes of the following disclosure, an “inquiry” is defined as any visitor to an event who provides their contact information. This may include a badge scan, an event registration, or other method such as tracking an application on the visitor's phone or logging location using FourSquare®, for example.

A “lead” is defined as a visitor who provides their contact information, answers the qualifying questions (as will be described herein), and has indicated that they have some role in the purchase of the event participant's/provider's products or services. “Leads” may be graded depending on how the visitor answers the qualification questions on the lead form (as will be described herein).

An “event” may be defined as any and all marketing experiences activated at conferences, conventions, meetings and trade shows hosted by 3rd party companies or organizations; a private, hosted event implemented by a single company or multiple companies in collaboration; or a live experience with a start/end date in a public setting and open to any and all audiences.

The present system and method includes a measurement system for event marketing activations. The system and method includes consistent metrics and measurements across events. The consistent metrics and measurements allow for an efficient and comprehensive measure of event impact, to develop normative data over time to create benchmarks for performance, to directly compare events to other events, and to provide a scalable and flexible measurement program that is able to handle large and small events and events in between.

In providing a measurement system for event marketing activations, it is beneficial to understand the business. A foundational understanding of what drives the company's business is desirable, such as: revenue; profitability; talent acquisition; competitive environment; share-of-wallet growth with existing customers; new customer acquisition; employee retention; industry buzz. These types of business drivers set the stage for setting event marketing objectives that align to business value.

Further, it may be desirable to talk to stakeholders, interview executives and others who have a stake in event marketing effectiveness and listen to their objectives and needs. It also may be desirable to talk to customers (and prospects).

The strategic objectives should be based upon what delivers the most value to the business. It may also be desirable to get organizational buy-off and approval on event marketing objectives.

The present system and method focus on why specific actions matter as opposed to what those actions are. Importantly, in measuring event impact, the metrics involved in the present system and method are based on the value created for the business, as opposed to simply data points about what happened at the event.

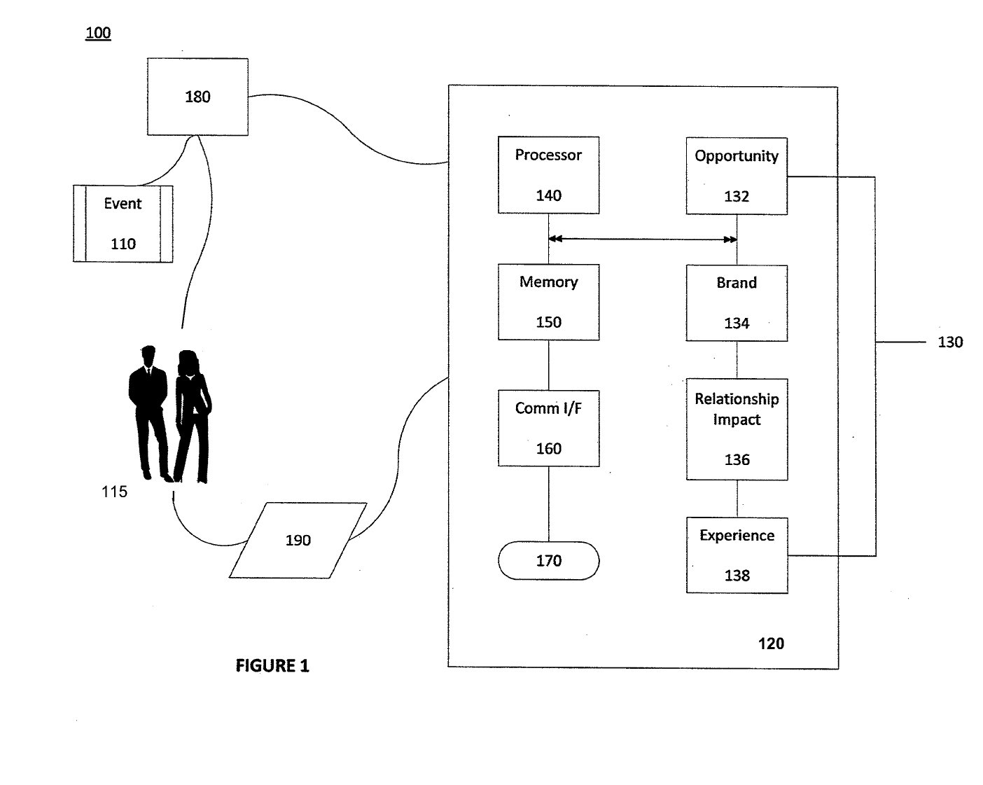

FIG. 1 illustrates an example system 100 for event measurement. System 100 includes an event 110 and visitors 115 that attend the event 110. Visitors 115 may provide feedback or other information to an enterprise system 120 via data input module 180. Enterprise system 120 may include a processor 140, a memory 150, a communication interface 160, and a database 170. From the provided information, enterprise system 120 may develop scoring 130 that is composed of an opportunity score 132, a brand score 134, a relationship impact score 136, and an experience score 138.

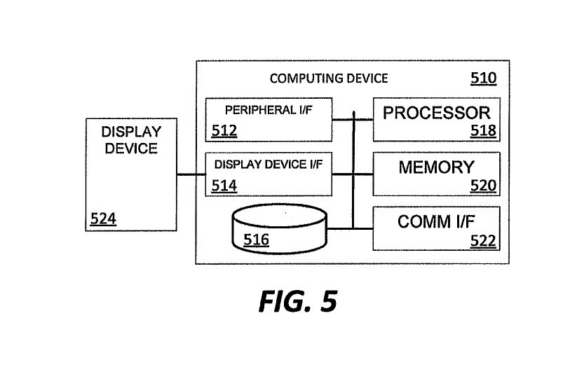

FIG. 1 shows an example architecture wherein features described herein may be implemented. The example architecture includes an enterprise system 120 that may be provided and accessed via a web site, a computing device, and the Internet. The system 120 of FIG. 1 includes hardware (such as one or more server computers) and software for providing and/or hosting the event measurement system as described. A computing device may be used to download and run a local application to intake data and provide analysis and scoring associated with the event measurement system. Alternatively, an end user may use a computing device to display and interact with the web pages that make up the enterprise system 120. The device shown in FIG. 5 and described below may be, for example, a laptop or desktop computer, a tablet computer, a smartphone, a PDA, and/or any other appropriate type of device.

Various methodologies may be employed for data collection via data input module 180 in system 100. For example, on-site personal intercept surveys, online surveys, and inquiry/lead analysis may be performed. Other input mechanisms may also be used, such as kiosk-based self-service surveys, on-site surveys, paper-based surveys, and application-based surveys, for example.

For on-site personal intercept surveys an intercept and interview may be performed with visitors to an exhibit and/or other on-site experiences, such as a breakout session or hospitality session, for example. This type of survey may provide increased usefulness for third party events where there may not be access to the attendee email list, for example. The intercept surveys may be performed by using objective surveyors to ask attendees and visitors to evaluate their experience as the attendees and visitors leave an event activation, such as a trade show booth. These surveys may be effective because people are generally willing to provide feedback and using conversation enables and encourages completion of the survey. Limitations may be placed on the individuals that are to be interviewed. For example, some exhibitors and press may be excluded. This type of data collection may be beneficial if there are 100 to 200 interviews completed. The survey may be kept short, such as five to seven minutes, for example.

These surveys lead to improved results when the event activation is large enough to attract sufficient traffic to obtain the required number of interviews. These interviews may be conducted on handheld electronic devices, paper, and/or other experience related methods. While each method of conducting interviews may provide adequate data, the electronic methods of conducting these interviews may provide additional benefits of saving the time required to tabulate the results and the ability to provide real-time results. Real-time results may allow for corrections in the course of the activation.

Surveys may be conducted by any number of personnel. Professional interviewers may be utilized to produce the highest quality data. Interviews may be conducted as visitors exit the activity. The visitors may be screened or weighted based on time dimensions, such as, but not limited to, the amount of interaction, time spent in the activation engaged with staff, and whether a demonstration was viewed, for example. A more general screening may also be used, such as screening people for interaction with staff, attendance at theater presentations or demonstrations, for example. Screening may also occur based on geography of origin and other characteristics, such as if the people are not the intended target of the event activation. Specific questions may be asked so that the data may be directed to specific segments of visitors. These specifics may include job title, type of business, size of company, for example.

The number of completed interviews may vary based on traffic experienced at the activation, the number of hours the activation remained open, and the number of interviewers, for example. By way of approximation, an interviewer may be able to complete forty interviews a day, assuming an eight hour day.

Post-event online surveys may also be used. This may include capturing email addresses, recording or monitoring all leads and badge swipes collected through event registrations, in the exhibit or ancillary activities. Generally, these types of surveys may provide benefit in situations where the surveyor does have the attendee list. An online survey may be distributed to attendees via email shortly before the event and after the event is over. This type of data collection may be beneficial if there are 500 or more surveys completed. This type of survey may be performed in addition to or instead of on-site surveys. The costs of this data collection method may be less than other methods. Each registrant may be emailed an invitation to participate in a follow-up interview survey. The link to the survey may be included with the invitation 190. Unique identifiers may be included within the invitation 190 or the link in order to ensure that respondents only respond once and to enable tracking to determine which invitees did not respond. The system may benefit from the information about who took the survey to allow the connection of survey responses to additional demographics that may be stored in a central database, such as an HRIS (Human Resources Information System) or a CRM (Customer Relationship Management) database, thereby permitting analysis of survey responses for specific demographic categories. This may allow an additional invitation 190 to be sent to those who failed to respond to the first invitation 190.

The survey invitations 190 may be sent to invitees before and immediately after the event. For example, post-event invitations 190 that are sent within one or two days after the event may provide the best responses and response rate. Follow-up contacts may also be used. These may include follow-ups to the initial surveys and/or contacting those that failed to respond to the initial invitation 190. Each of these follow-ups may be sent approximately one week after the initial request and may be slightly spaced in time from each other. An incentive may be included with the invitation 190 to encourage responses.

Personal observations of event staff captured via an online or paper-based survey may be used to augment the quantitative measurements and may provide value in interpreting the results of attendee or visitor surveys and to enable optimization of performance in future events. This type of survey may provide the “why” behind attendee survey results. The personal observations may also be of value in memorializing the activities at the event for use in planning the next event. This may include staff observations of what worked and what did not. This type of survey may include a web-based survey administered to everyone that worked at an event and may be filled out at the completion of the event.

Inquiry/Lead analysis is another aspect of the standardized measurement protocol that may be included for events when inquiries are obtained. This is generally practical and cost-effective. Questions may be asked to qualify an attendee as a cold, warm, or hot lead, for example. At the moment of lead capture, several questions may help prioritize individuals that should be followed up with immediately after the event. This approach analyzes inquiries and categorizes leads in a multitude of ways.

The first step in this analysis may begin by establishing an overall goal for the number of qualified leads. The second step may include qualification of inquiries to determine which of the inquiries are considered qualified leads for follow-up. Qualification as used herein includes a system which differentiates leads based upon their potential to buy, using two qualification questions: (1) role in buying including final say, specify brand/supplier, recommender, or no role; and (2) time frame for purchase including XX days/months or less, more than XX days/months, or no plans to purchase, where the time frame may be defined by the company or industry. The particular categorization of leads for qualification purposes may include A leads (role in purchase/time frame to purchase in XX days/months or less), B leads (role in purchase/time frame to purchase more than XX days/months), C leads (role in purchase/no plans to purchase), and unqualified leads (no role in purchase). Ungraded inquiries have an unknown role and unknown purchasing plans.

Generally, the sum of A, B, C, unqualified, and ungraded inquiries equals the number of total inquiries. Percentage of lead qualification goal achieved is the total number of qualified A and B leads acquired as a percentage of qualified lead goal. The number of ungraded leads may provide insight into the number of inquiries that personnel are actually qualifying. If the number of ungraded inquiries is high relative to those who have been qualified, it is an indication that at least one of the staff are not qualifying the visitors that are engaged. In addition, qualification may also occur post event through follow-up communications with inquiries collected on-site.

Once the data is input into system 100, the data may be organized and analyzed to provide scoring metrics 130.

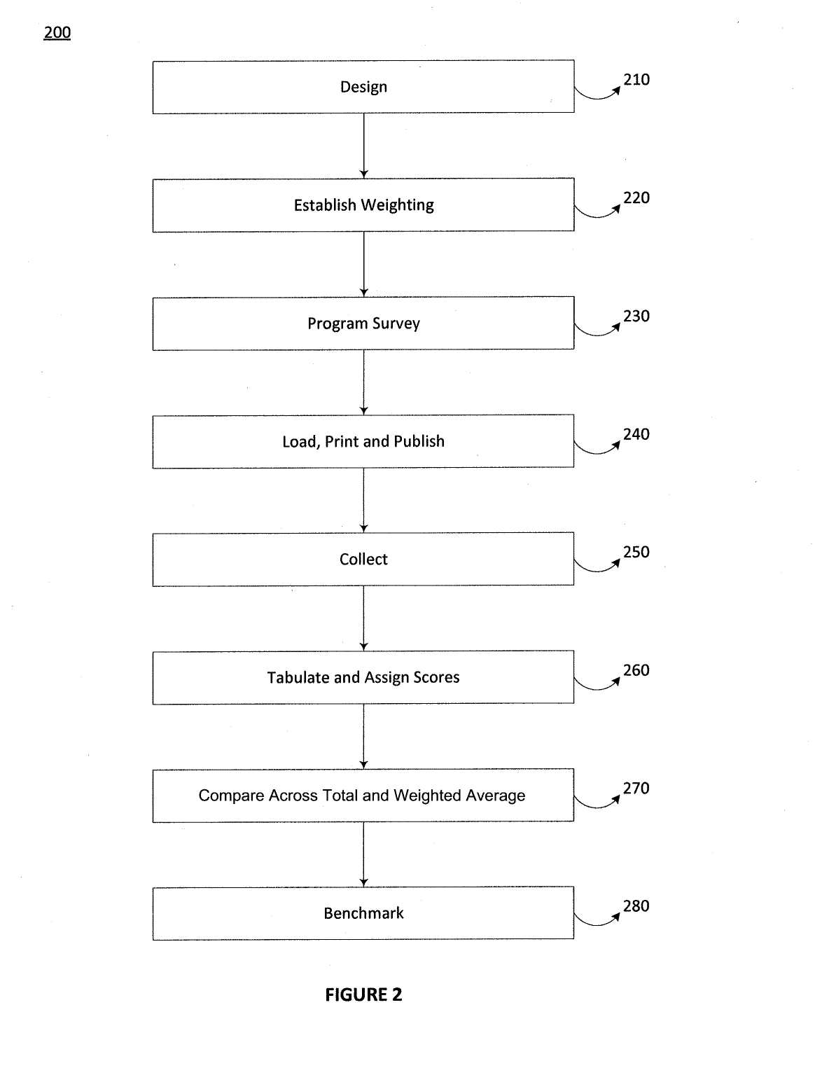

FIG. 2 illustrates a method 200 for event measurement. Method 200 includes the steps of design 210, establish weighting 220, program survey 230, load, print and publish 240, collect 250, tabulate and assign scores 260, compare across total and weighted average 270, and benchmark 280.

More specifically, the method 200 for event measurement may include design at step 210. Design 210 may include preparing the specifics of the event measurement. Design 210 may include identifying the objective, identifying the data collection method(s), and developing and identifying survey questions. The step of design 210 may include finalizing the questions to ask including customization of the questions and sets of questions in order to meet the objective from the design 210. For example, questions may be categorized by metric. Design 210 may also include providing an organizational flow to appropriately order the questions to be presented. The questions to be used may be finalized, such as by selecting five questions, from an optional 10 questions per metric. Design 210 may also include determining whether any customized (one-off) questions need to be added. Design 210 may also include eliminating question bias.

Establishing the weighting 220 may include deciding how to weight each of the metrics in the calculation of the weighted score. Establishing 220 may further assign emphasis by metric.

Method 200 may include programming the survey at step 230. Programming the survey may include customization of the survey to the questions selected, the order selected and the flow of the survey, for example.

Once the survey is programmed at step 230, the survey may be loaded, print and published at step 240.

Method 200 may include collect 250. Collect 250 may include collection of data and information regarding the event 110. This may include live and/or post-event surveys and personal observations. Collect 250 may include interaction with a brand representative and modifying the survey in order to create better data realizing of course that such modifications may limit post-event data aggregation and comparison. Electronic data may be analyzed in real-time, for example, such as by making course corrections to the event based on preliminary attendee feedback, for example.

Tabulate and assign scores 260 may include processing the collected data of step 250 using processor 140. This may include tabulating and assigning scores of step 260 such as individual scores for each of the scoring 130 metrics. Additional calculations may include tabulating of step 260 total and weighted events scores. Assigning scores may also include reviewing inquiries and leads and providing grades for each one.

Compare across total and weighted average 270 may include interpreting results and identifying actionable recommendations for improving performance and maximizing event value. Score results may also be analyzed at step 270. Free response answers and observations may be analyzed at step 270. These responses may be interpreted to provide methods and ways of improving performance and/or maximizing event value.

Benchmark 280 may include establishing average scores based on data across multiple events. Benchmark 280 may include and/or provide the ability to compare data across multiple events, such as by saying the score for this event is X and the average score for similar types of events is Y. Benchmark of step 280 may also include providing recommendations for improvement based on results.

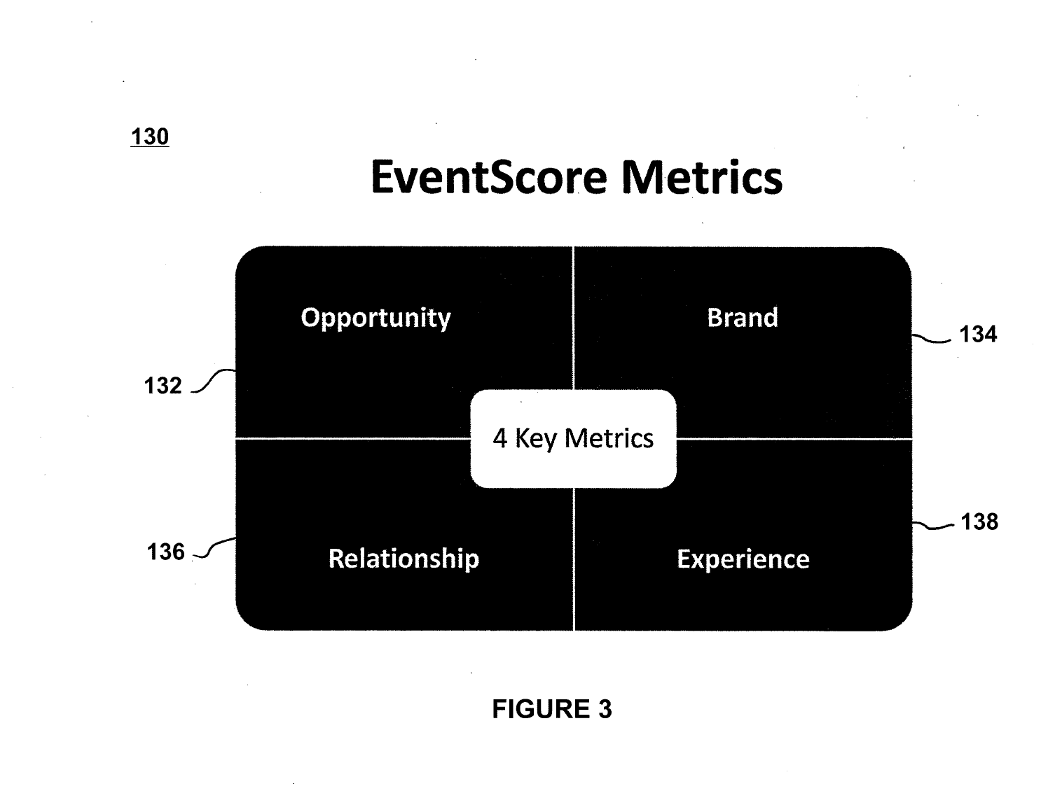

FIG. 3 illustrates the four individual scores 130 utilized in system 100. The present system 100 and method capture the results for four individual scores 130. This capture may be for an individual event 110, a series of related or unrelated events, or across a campaign of events, for example. These individual scores 130 include opportunity score 132, brand score 134, relationship impact score 136, and experience score 138.

The opportunity score 132 measures the potential of sales opportunities generated for the products, services, solutions to those exposed visitors 115 to the event 110. This opportunity score 132 is related to business potential of the activity. Rather than trying to measure return on investment, the focus may be placed on measuring opportunity via an opportunity score 132. Events are opportunity creators—getting prospects interested in products, expanding product consideration with existing customers. It's (usually) up to marketing and/or sales departments to nurture and convert these opportunities, but the event team can be held accountable for driving opportunity back to the business as demonstrated via the opportunity score 132.

The brand score 134 measures the impact of the event 110 on event attendee brand perception. This may include a measure of customer or prospect awareness, loyalty, and/or satisfaction with the brand. This score 134 may account for any change in brand perception 115. Events are brand experiences, and event attendees are likely to think differently about companies after attending an event. Because people tend to buy more from brands they like and respect, it's important to recognize and measure the impact of the event on brand perceptions via a brand score 134.

The relationship impact score 136 measures the quality of relationship with a customer or prospect as a result of the exposure to the brand at an event 110. This score 136 may include the impact to existing customers, which may include event 110 attendees 115. Networking always rises to the top of attendees' reasons for attending events. Event marketers know that the greatest impact is the human interaction that occurs at an event—and that stronger relationships can result. The relationship impact score 136 may evaluate the event's effect on the quality and strength of relationships, particularly with existing customers.

These three metrics are critical indicators of the business value that an event can drive, but measurement is also crucial to improving events.

The fourth metric is designed to reflect that goal. The experience score 138 may measure the quality of experience based on exposure and interaction with individual events 110. This score 138 may include event performance and expectations of visitors 115. Capturing data against the quality of attendee/visitor experiences is paramount for identifying areas for improvement. The experience score 138 may be used to evaluate whether the content, staff, the design and other elements are delivering upon attendee expectations, and identify areas to improve with the resulting data.

A scoring tool 130 may be used to score each event. Selected questions from the surveys may be included to calculate a score for each of the four key areas of performance including the opportunity score 132, brand score 134, relationship impact score 136, and experience score 138. The first three scores 132, 134, 136 may indicate the business value delivered by the event 110 and the experience score 138 may inform performance improvement decisions for future events 110.

In addition, system 100 and method 200 may include two additional overall metrics that combine the individual scores 130 or opportunity score 132, brand score 134, relationship impact score 136, and experience score 138, to provide simple numerical scores for the event 110. These two additional metrics are the total event score and a weighted total event score. The total event score provides an overall, un-weighted score for the event 110 based on the average of the individual scores 130. The weighted total event score allows for weighting of the relative importance of each individual score. The weighted score may use a 100-point allocation across the four individual scores 130 to provide a single weighted score for each event 110. For example, while each of the four individual scores 130 may be rated out of 5, the single weighted score for each event 110 may be a composite of the four individual scores with allocations for each score based on a 100-point scale. For example, score 1 may be 25% of the total, score 2 may be 50%, score 3 may be 10%, and score 4 may be 15% of the total 100% score. This score may also have equal weighting of 25% for each individual score.

A score for each of the individual scores 130 (opportunity score 132, a brand score 134, a relationship impact score 136, and an experience score 138) may be calculated using the following example. For each of the questions with a five-point scale, an average may be calculated using the values 5, 4, 3, 2, and 1. For questions with a three-point scale, the values may be 5, 3, and 1. Questions with multiple criteria to rate may be calculated using one average per question not considering the number of criteria being rated for the particular question. In scoring the answer to a question, averages may be based on those answering specific questions excluding “not applicable” and questions not answered, for example. The qualified lead score is calculated by multiplying the percentage of goal achieved by five to convert it to a 5 point scale for consistency in scoring with the other questions.

Another dimension to lead qualification and scoring may be utilized. In this case “revenue potential” may be calculated by tabulating the number of A+B leads and multiplying this calculation by an “average sell-price” of a purchase to provide an overall revenue potential number. For example, if 10 A&B leads are captured and the average sale for the types of products presented is $1,000, the revenue potential is $10,000.

The overall average score for each of the four individual scores is calculated by computing the average for all questions and scores that comprise each score. The total event score is calculated by averaging the scores for the four individual scores. Individual scores may also be weighted by the level of importance a company places on each of the four score areas for a specific event as described above to produce a weighted total event score.

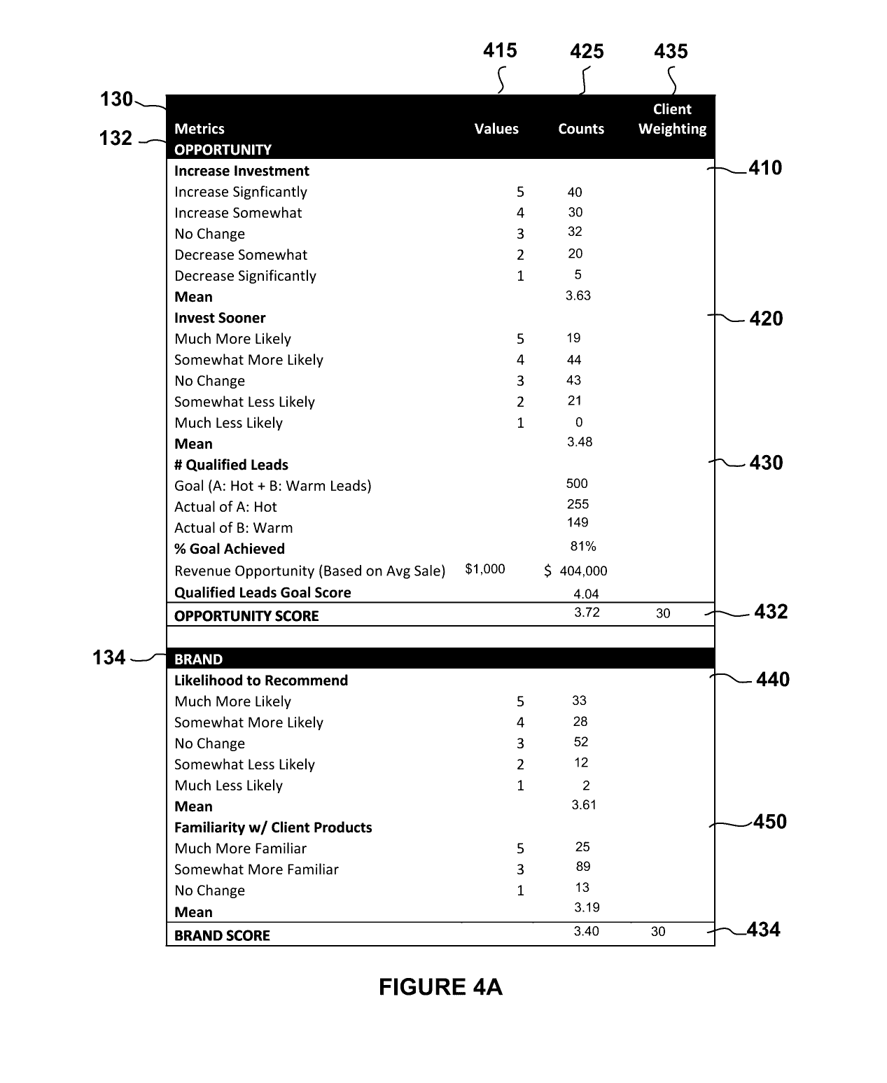

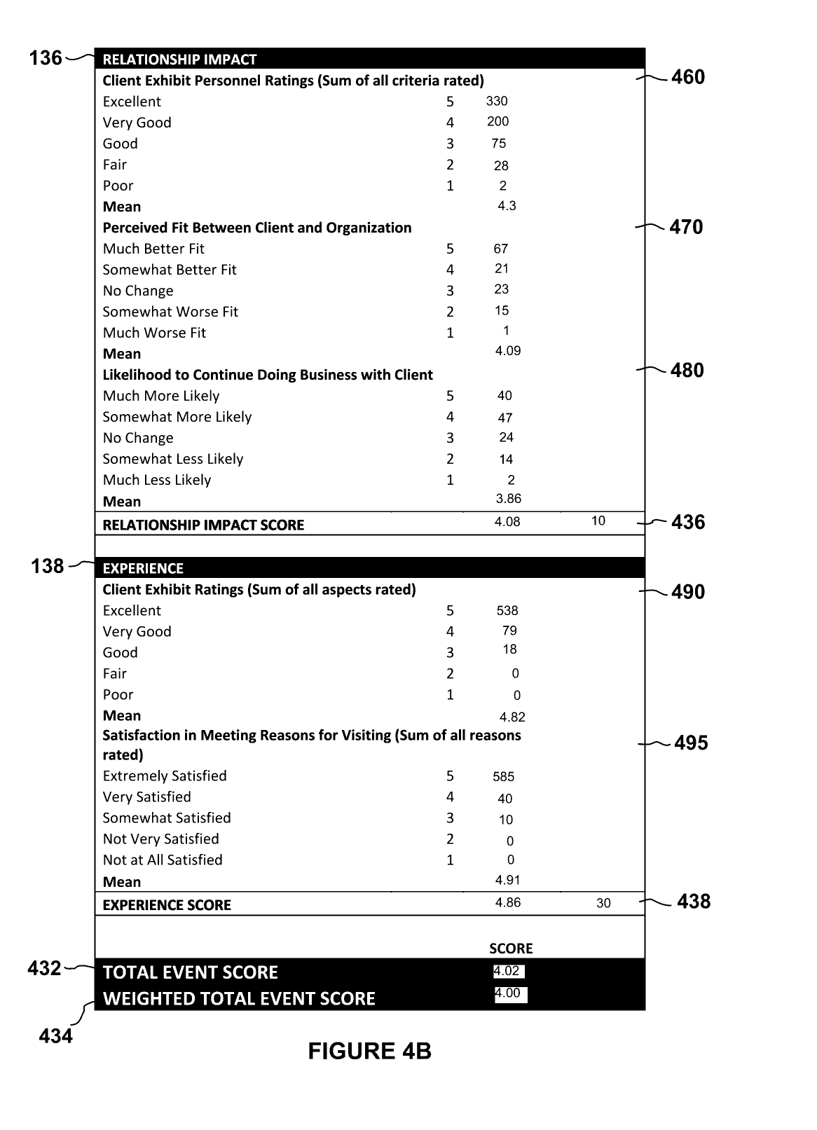

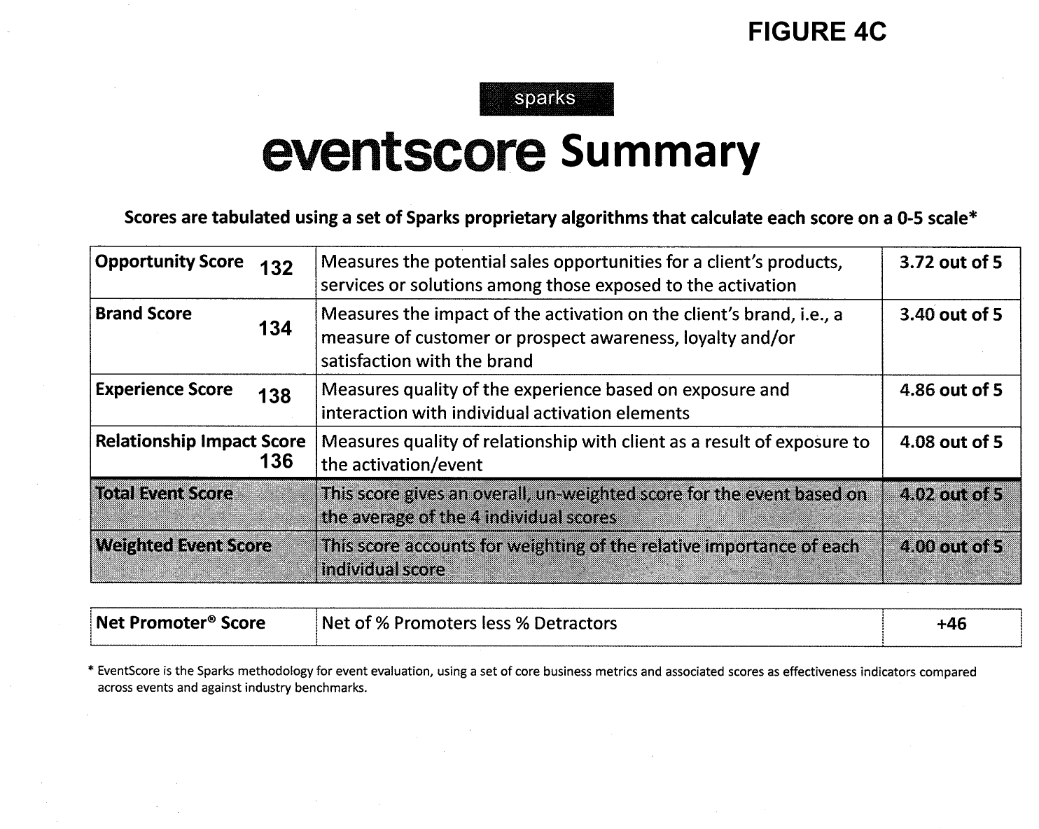

FIGS. 4A and 4B illustrate a screen shot of the calculation of the total event score 432, the weighted score 434, and the individual scores 130 including opportunity score 132, a brand score 134, a relationship impact score 136, and an experience score 138. As is illustrated in FIGS. 4A and 4B, metrics 130 may be composed of the respective metrics of opportunity score 132, a brand score 134, a relationship impact score 136, and an experience score 138. These individual scores 130 may lead to the calculation of the total event score 432 and the weighted score 434. Client weighting 435 may be included to account for the importance of a given factor to the individual score 130 or to the total event score 432 from the perspective of the company.

Turning first to the opportunity score 132. A ratings system may be employed to gather information such as the impact of the event on attendee/visitor expectations for future levels of investment in products/services (“increase investment”) 410. The response to this query may be input with a value 415 from 5 to 1, with 5 representing increase significantly, 4 representing increase somewhat, 3 representing no change, 2 representing decrease somewhat, and 1 representing decrease significantly. An aggregate of the various scores for the event may be included in counts 425. That is, if there are fifty scores of 5 entered for increase investment 410, the counts may identify 50 for the value 5 associated with increase investment 410. As shown the opportunity score 132 may include information based on increasing investment 410, investing sooner 420 and number of qualified leads 430.

The impact of the event on attendee/visitor expectations for timeframe of purchase for products/services (“invest sooner”) 420 may be scored in a similar fashion to increasing investment 410 described above. Qualified leads 430 may identify hot leads (A leads) and warm leads (B leads) and may combine these lead types to determine a percent goal achieved. Further, these leads may be multiplied by the revenue opportunity, such as based on the company's average sale price, to determine the qualified leads score. A composite of increased investment 410, invest sooner 420, and qualified leads score 430 may then be combined using scores 415, counts 425 and client weighting 435 to yield the opportunity score 132.

In determining the brand score 434, two categories in the ratings system may be employed to gather information including impact of the event on attendee/visitor likelihood to recommend the brand (“likelihood to recommend”) 440 and the impact of the event on attendee/visitor levels of familiarity with company products/services (“familiarity with client products”) 450. Both of these categories may be scored in line with the description of increase investment 410 hereinabove. Likelihood to recommend 440 and familiarity with clients products 450 may then be combined using scores 415, counts 425 and client weighting 435 to form the brand score 434.

Similarly, relationship impact 136 may utilize a ratings system employed to gather information focused on personnel ratings 460, the impact of the event on attendee/visitor perceptions of the perceived fit between the company and their organization's culture (“perceived fit between customer and organization”) 470, and the impact of the event on attendee/visitor expectations of their likelihood to continue doing business with the company (“likelihood to continue doing business with client”) 480. Each of these categories may be scored in line with the description of increase investment 410 hereinabove. Personnel rating 460, perceived fit 470, and likelihood of continuing to do business with the company 480 may then be combined using scores 415, counts 425 and client weighting 435 to determine the relationship impact score 136.

The experience metric 138 may utilize a ratings system employed to gather information based on client exhibit ratings 490 and attendee/visitor levels of satisfaction in meeting their reasons for attending the event (“satisfaction in meeting reasons for visiting”) 495. Each of these categories may be scored in line with the description of increase investment 410 hereinabove. Client exhibit ratings 490 and satisfaction in meeting reasons for visiting 495 may then be combined using scores 415, counts 425 and client weighting 435 to achieve an experience score 138.

Specifically looking at the exemplary values 415 and counts 425 to calculate a score such as the opportunity score 132 may include a review and tabulation of the scores associated with opportunity 132, for example. That is, the number of “5” scores, “4” scores, “3” scores, “2” scores, and “1” scores may be tabulated and recorded in counts 425 corresponding to the respective score. For example, in opportunity 132 under the “Increase Investment” portion there are 40 “5” counts recorded, 30 “4” counts, 32 “3” counts, 20 “2” counts, and 5 “1” counts. Using weighting this may correlate to an mean score of 3.63. The mean score may be calculated in any number of ways, including, for example, an aggregate of 5×40+4×30+3×32+2×20+1×5, representing each of the counts 425 recorded for a given value 415. In this example, this represents an aggregate amount of 461. This may be based on the number of recorded scores 40+30+32+20+5 for the 127 recorded values. Using a mean analysis this aggregate amount of 461 over 127 recorded values results in a mean of 3.63 for the “Increase Investment” portion of the opportunity score 132.

For example, in opportunity 132 under the “Invest Sooner” portion there are 19 “5” counts recorded, 44 “4” counts, 43 “3” counts, 21 “2” counts, and 0 “1” counts. Using weighting this may correlate to an mean score of 3.48. The mean score may be calculated in any number of ways, including, for example, an aggregate of 5×19+4×44+3×43+2×21+1×0, representing each of the counts 425 recorded for a given value 415. In this example, this represents an aggregate amount of 442. This may be based on the number of recorded scores 19+44+43+21+0 for the 127 recorded values. Using a mean analysis this aggregate amount of 442 over 127 recorded values results in a mean of 3.48 for the “Invest Sooner” portion of the opportunity score 132.

Similarly, in our example, the “# of Qualified Leads” score may be calculated by identifying a Goal for the number of Hot and Warm leads, in this case 500. The actual hot and warm leads may be recorded in the counts 425, such as 255 hot leads and 149 warm leads. By summing 225+149 and dividing by the goal of 500 a determination of the % goal achieved of 81%. Based on recorded revenue opportunity, in this case $1,000, the 404 hot plus warm leads amounts to a revenue opportunity of $404,000. The qualified leads goal score may then be calculated as 4.04 for the “# of Qualified Leads” portion of the opportunity score 132. This “Qualified Leads” score may be calculated by multiplying the percentage of goal achieved by five. This converts the score to a 5-point scale consistent with the scoring of other questions.

The opportunity score 132 may then be calculated by averaging the scores from the portions of “Increase Investment,” “Invest Sooner” and “# of Qualified Leads” to provide the resulting score. In this example, that is the average of 3.63, 3.48 and 4.04 result in an average 3.72 that is the opportunity score 132.

The brand score 134 may be similarly calculated. In the brand score 134 there are two components, “Likelihood to Recommend” and “Familiarity with Client Products.” For example, in brand score 134 under the “Likelihood to Recommend” portion there are 33 “5” counts recorded, 28 “4” counts, 52 “3” counts, 12 “2” counts, and 2 “1” counts. Using weighting this may correlate to a mean score of 3.61. The mean score may be calculated in any number of ways, including, for example, an aggregate of 5×33+4×28+3×52+2×12+1×2, representing each of the counts 425 recorded for a given value 415. In this example, this represents an aggregate amount of 459. This may be based on the number of recorded scores 33+28+52+12+2 for the 127 recorded values. Using a mean analysis this aggregate amount of 459 over 127 recorded values results in a mean of 3.61 for the “Likelihood to Recommend” portion of the brand score 134.

For example, in brand score 134 under the “Familiarity with Client Products” portion there are 25 “5” counts recorded, 89 “3” counts, and 13 “1” counts. Using weighting this may correlate to a mean score of 3.19. Generally scores are rated by respondents on a 5-point Likert scale. Five has been shown to be an optimal number on such a scale, although any number of points may be used. “Familiarity” has only three levels as a result of the nature of the topic. “Familiarity,” may significantly increase, somewhat increase, or not increase. The system modifies the 1, 2, 3 response to 1, 3, 5 to convert to a 5-point scale consistent with the other scoring.

The mean score may be calculated in any number of ways, including, for example, an aggregate of 5×25+3×89+1×13, representing each of the counts 425 recorded for a given value 415. In this example, this represents an aggregate amount of 405. This may be based on the number of recorded scores 25+89+13 for the 127 recorded values. Using a mean analysis this aggregate amount of 405 over 127 recorded values results in a mean of 3.19 for the “Familiarity with Client Products” portion of the brand score 134.

The brand score 134 may then be calculated by averaging the scores from the portions of “Likelihood to Recommend” and “Familiarity with Client Products” to provide the resulting score. In this example, that is the average of 3.61 and 3.19 result in an average 3.40 that is the brand score 134.

For example, in relationship impact 136 under the “Client Exhibit Personnel Ratings” portion there are 330 “5” counts recorded, 200 “4” counts, 75 “3” counts, 28 “2” counts, and 2 “1” counts. Using weighting this may correlate to an mean score of 4.30. The mean score may be calculated in any number of ways, including, for example, an aggregate of 5×330+4×200+3×75+2×28+1×2, representing each of the counts 425 recorded for a given value 415. In this example, this represents an aggregate amount of 2733. This may be based on the number of recorded scores 330+200+75+28+2 for the 635 recorded values. Using a mean analysis this aggregate amount of 2733 over 635 recorded values results in a mean of 4.30 for the “Client Exhibit Personnel Ratings” portion of the relationship impact score 136. For questions with multiple criteria, one average per question is calculated regardless of the number of criteria being rated for that question. This affects three items, for a summary of all criteria rated: Client exhibit personnel ratings, client exhibit ratings, and satisfaction for meeting reasons for visit.

For example, in relationship impact 136 under the “Perceived Fit Between Client and Organization” portion there are 67 “5” counts recorded, 21 “4” counts, 23 “3” counts, 15 “2” counts, and 1 “1” counts. Using weighting this may correlate to an mean score of 4.09. The mean score may be calculated in any number of ways, including, for example, an aggregate of 5×67+4×21+3×23+2×15+1×1, representing each of the counts 425 recorded for a given value 415. In this example, this represents an aggregate amount of 519. This may be based on the number of recorded scores 67+21+23+15+1 for the 127 recorded values. Using a mean analysis this aggregate amount of 519 over 127 recorded values results in a mean of 519 for the “Perceived Fit Between Client and Organization” portion of the relationship impact score 136.

For example, in relationship impact 136 under the “Likelihood to Continue Doing Business with Client” portion there are 40 “5” counts recorded, 47 “4” counts, 24 “3” counts, 14 “2” counts, and 2 “1” counts. Using weighting this may correlate to an mean score of 3.86. The mean score may be calculated in any number of ways, including, for example, an aggregate of 5×40+4×47+3×24+2×14+1×2, representing each of the counts 425 recorded for a given value 415. In this example, this represents an aggregate amount of 490. This may be based on the number of recorded scores 40+47+24+14+2 for the 127 recorded values. Using a mean analysis this aggregate amount of 490 over 127 recorded values results in a mean of 3.86 for the “Likelihood to Continue Doing Business with Client” portion of the relationship impact score 136.

The relationship impact score 136 may then be calculated by averaging the scores from the portions of “Client Exhibit Personnel Ratings,” “Perceived Fit Between Client and Organization” and “Likelihood to Continue Doing Business with Client” to provide the resulting score. In this example, that is the average of 4.30, 4.09 and 3.86 result in an average 4.08 that is the relationship impact score 136.

Continuing the present example, in experience 138 under the “Client Exhibit Ratings” portion there are 538 “5” counts recorded, 79 “4” counts, 18 “3” counts, 0 “2” counts, and 0 “1” counts. Using weighting this may correlate to an mean score of 4.82. The mean score may be calculated in any number of ways, including, for example, an aggregate of 5×538+4×79+3×18+2×0+1×0, representing each of the counts 425 recorded for a given value 415. In this example, this represents an aggregate amount of 3060. This may be based on the number of recorded scores 538+79+18+0+0 for the 635 recorded values. Using a mean analysis this aggregate amount of 3060 over 635 recorded values results in a mean of 4.82 for the “Client Exhibit Ratings” portion of the experience score 138. For questions with multiple criteria, one average per question is calculated regardless of the number of criteria being rated for that question. This affects three items, for a summary of all criteria rated: Client exhibit personnel ratings, client exhibit ratings, and satisfaction for meeting reasons for visit.

For example, in experience 138 under the “Satisfaction in Meeting Reasons for Visiting” portion there are 585 “5” counts recorded, 40 “4” counts, 10 “3” counts, 0 “2” counts, and 0 “1” counts. Using weighting this may correlate to an mean score of 4.91. The mean score may be calculated in any number of ways, including, for example, an aggregate of 5×585+4×40+3×10+2×0+1×0, representing each of the counts 425 recorded for a given value 415. In this example, this represents an aggregate amount of 3115. This may be based on the number of recorded scores 585+40+10+0+0 for the 635 recorded values. Using a mean analysis this aggregate amount of 3115 over 635 recorded values results in a mean of 4.91 for the “Satisfaction in Meeting Reasons for Visiting” portion of the experience score 138.

The experience score 138 may then be calculated by averaging the scores from the portions of “Client Exhibit Ratings” and “Satisfaction in Meeting Reasons for Visiting” to provide the resulting score. In this example, that is the average of 4.82 and 4.91 result in an average 4.86 that is the experience score 138.

From there the respective scores 132, 134, 136 and 138 may be combined to achieve a total event score 432. In this example, the combination would be the average of the opportunity score 132 of 3.72, the brand score 134 of 3.40, the relationship impact score 136 of 4.08 and the experience score 138 of 4.86. In this case, the total event score 432 is 4.02.

A weighted total event score 434 may also be calculated. In this example, the combination would be the weighted average of the opportunity score 132 of 3.72 by its weight 432 of 30, the brand score 134 of 3.40 by its weight 434 of 30, the relationship impact score 136 of 4.08 by its weight 436 of 10 and the experience score 138 of 4.86 by its weight 438 of 30. In this case, the weighted total event score 434 is 4.00.

The system may run correlations to see if scores in some areas are significantly related to scores in other areas. A summary of the scores is shown in FIG. 4C. As shown in FIG. 4C, the opportunity score 132, which measures the potential sales opportunities for a company's products, services or solutions among those exposed to the activation, may be 3.72 out of 5. The brand score 134, which measures the impact of the activation on the company's brand, a measure of customer or prospect awareness, loyalty and/or satisfaction with the brand, may be 3.4 out of 5. The experience score 138, which measures the quality of the experience based on exposure and interaction with individual activation elements, may be 4.86 out of 5. The relationship impact score 136, which measures the quality of the relationship between the company and attendees/visitors (particularly current customers) as a result of exposure to the activation/event, may be 4.08 out of 5.

These metric scores may be averaged to provide a total event score, which is an overall, un-weighted score for the event based on the average of the four individual scores, 132, 134, 136, 138, may be 4.02 out of 5. The weighted total event score may also be calculated. The weighted event score, which accounts for weighting of the relative importance of each individual score, 132, 134, 136, 138, may be 4 out of 5.

In addition, as shown in FIG. 4C, a net promoter score, which is a net of % promoters less % detractors may be provided. In this instance, the net promoter score is +46.

Questionnaire templates may be provided and may be customized to a particular company. The questionnaires may be similar across all types of events/methodologies. Some questions may have specific wording changed to be more appropriate for that type of methodology and/or type of event. Questions may be designated with particular color coding to designate optional questions.

The enterprise system may include a web server module, a web application module, and a database, which, in combination, store and process data for use in the web site. The web application module may provide the logic behind the web site, and/or perform functionality related to the generation of the web pages. The web application may communicate with the web server module for generating and serving the web pages that make up the web site.

The computing device may include a web browser module, which may receive, display, and interact with the web pages provided by the web site system. The web browser module in the computing device may be, for example, a web browser program such as Internet Explorer, Firefox, Opera, Safari, and/or any other appropriate web browser program. To provide the web site to the user of the computing device, the web browser module in the computing device and the web server module may exchange HyperText Transfer Protocol (HTTP) messages, per current approaches that would be familiar to skilled person.

As described hereinabove, details regarding the interactive web site and the pages of the web site (as generated by the web site system and displayed/interacted with by the user of the computing device) are provided.

The components in the web site system (web server module, web application module, outgoing video module) may be implemented across one or more computing devices (such as, for example, server computers), in any combination.

The database in the web site system may be or include one or more relational databases, one or more hierarchical databases, one or more object-oriented databases, one or more flat files, one or more structured files, and/or one or more other files for storing data in an organized/accessible fashion. The database may be spread across any number of computer-readable storage media. The database may be managed by one or more database management systems in the web site system, which may be based on technologies such as Microsoft SQL Server, MySQL, PostgreSQL, Oracle Relational Database Management System (RDBMS), a NoSQL database technology, and/or any other appropriate technologies and/or combinations of appropriate technologies. The database in the web site system may store information related to the web site provided by the web site system, including but not limited to any or all information described herein as necessary to provide the features offered by the web site.

The web server module implements the Hypertext Transfer Protocol (HTTP). The web server module may be, for example, an Apache web server, Internet Information Services (IIS) web server, nginx web server, and/or any other appropriate web server program. The web server module may communicate HyperText Markup Language (HTML) pages, handle HTTP requests, handle Simple Object Access Protocol (SOAP) requests (including SOAP requests over HTTP), and/or perform other related functionality.

The web application module may be implemented using technologies such as PHP: Hypertext Preprocessor (PHP), Active Server Pages (ASP), Java Server Pages (JSP), Zend, Python, Zope, Ruby on Rails, Asynchronous JavaScript and XML (Ajax), and/or any other appropriate technology for implementing server-side web application functionality. In various implementations, the web application module may be executed in an application server (not depicted in FIG. 5) in the web site system that interfaces with the web server module, and/or may be executed as one or more modules within the web server module or as extensions to the web server module. The web pages generated by the web application module (in conjunction with the web server module) may be defined using technologies such as HTML (including HTML5), eXtensible HyperText Markup Language (XHMTL), Cascading Style Sheets, Javascript, and/or any other appropriate technology.

Alternatively or additionally, the web site system may include one or more other modules (not depicted) for handling other aspects of the web site provided by the web site system.

The web browser module in the computing device may include and/or communicate with one or more sub-modules that perform functionality such as rendering HTML, rendering raster and/or vector graphics, executing JavaScript, decoding and rendering video data, and/or other functionality. Alternatively or additionally, the web browser module may implement Rich Internet Application (RIA) and/or multimedia technologies such as Adobe Flash, Microsoft Silverlight, and/or other technologies, for displaying video. The web browser module may implement RIA and/or multimedia technologies using one or web browser plug-in modules (such as, for example, an Adobe Flash or Microsoft Silverlight plugin), and/or using one or more sub-modules within the web browser module itself. The web browser module may display data on one or more display devices (not depicted) that are included in or connected to the computing device, such as a liquid crystal display (LCD) display or monitor. The computing device may receive input from the user of the computing device from input devices (not depicted) that are included in or connected to the computing device, such as a keyboard, a mouse, or a touch screen, and provide data that indicates the input to the web browser module.

Although the example architecture of FIG. 1 shows a single computing device, this is done for convenience in description, and it should be understood that the architecture of FIG. 1 in may include, mutatis mutandis, any number of computing devices with the same or similar characteristics as the described computing device.

Although the methods and features are described herein with reference to the example architecture of FIG. 1, the methods and features described herein may be performed, mutatis mutandis, using any appropriate architecture and/or computing environment. Alternatively or additionally, although examples are provided herein in terms of web pages generated by the web site system, it should be understood that the features described herein may also be implemented using specific-purpose company/server applications. For example, each or any of the features described herein with respect to the web pages in the interactive web site may be provided in one or more specific-purpose applications. For example, the features described herein may be implemented in mobile applications for Apple iOS, Android, or Windows Mobile platforms, and/or in client application for Windows, Linux, or other platforms, and/or any other appropriate computing platform.

For convenience in description, the modules (web server module, web application module, and web browser module) shown in FIG. 1 are described herein as performing various actions. However, it should be understood that the actions described herein as performed by these modules are in actuality performed by hardware/circuitry (i.e., processors, network interfaces, memory devices, data storage devices, input devices, and/or display devices) in the electronic devices where the modules are stored/executed.

FIG. 5 shows an example computing device 510 that may be used to implement features describe above with reference to FIGS. 1-4. The computing device 510 includes a processor 518, memory device 520, communication interface 522, peripheral device interface 512, display device interface 514, and data storage device 516. FIG. 5 also shows a display device 524, which may be coupled to or included within the computing device 510.

The memory device 520 may be or include a device such as a Dynamic Random Access Memory (D-RAM), Static RAM (S-RAM), or other RAM or a flash memory. The data storage device 516 may be or include a hard disk, a magneto-optical medium, an optical medium such as a CD-ROM, a digital versatile disk (DVDs), or Blu-Ray disc (BD), or other type of device for electronic data storage.

The communication interface 522 may be, for example, a communications port, a wired transceiver, a wireless transceiver, and/or a network card. The communication interface 522 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 512 is configured to communicate with one or more peripheral devices. The peripheral device interface 512 operates using a technology such as Universal Serial Bus (USB), PS/2, Bluetooth, infrared, serial port, parallel port, and/or other appropriate technology. The peripheral device interface 512 may, for example, receive input data from an input device such as a keyboard, a mouse, a trackball, a touch screen, a touch pad, a stylus pad, and/or other device. Alternatively or additionally, the peripheral device interface 512 may communicate output data to a printer that is attached to the computing device 510 via the peripheral device interface 512.

The display device interface 514 may be an interface configured to communicate data to display device 524. The display device 524 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 514 may operate using technology such as Video Graphics Array (VGA), Super VGA (S-VGA), Digital Visual Interface (DVI), High-Definition Multimedia Interface (HDMI), or other appropriate technology. The display device interface 514 may communicate display data from the processor 518 to the display device 524 for display by the display device 524. As shown in FIG. 5, the display device 524 may be external to the computing device 510, and coupled to the computing device 510 via the display device interface 514. Alternatively, the display device 524 may be included in the computing device 500.

An instance of the computing device 510 of FIG. 5 may be configured to perform any feature or any combination of features described above as performed in system 100. Alternatively or additionally, the memory device 520 and/or the data storage device 516 may store instructions which, when executed by the processor 518, cause the processor 518 to perform any feature or any combination of features described above. Alternatively or additionally, each or any of the features described above as performed may be performed by the processor 518 in conjunction with the memory device 520, communication interface 522, peripheral device interface 512, display device interface 514, and/or storage device 516.

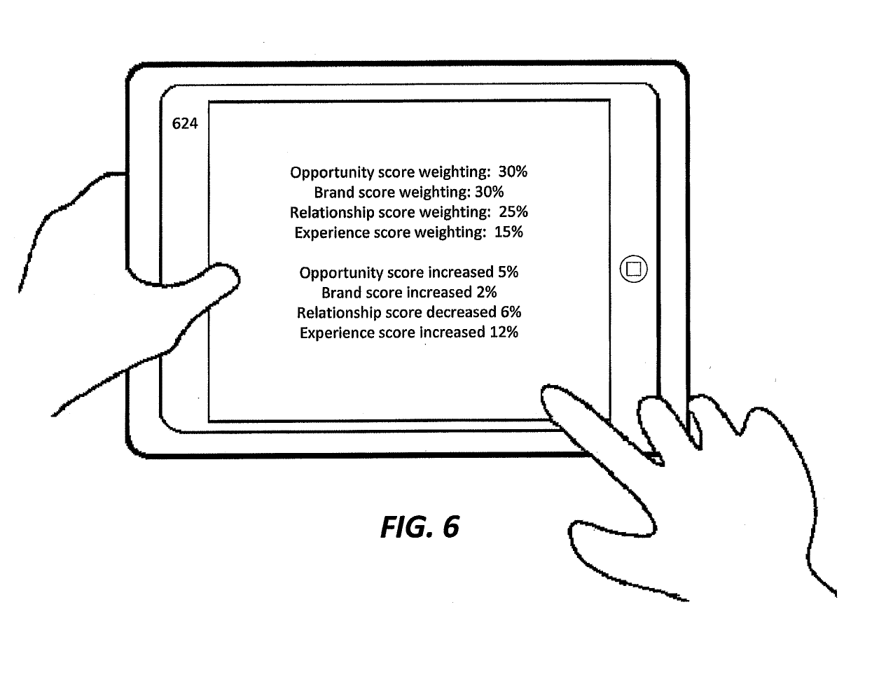

FIG. 6 shows a tablet computer 610 that is a more specific example of the computing device 510 of FIG. 5. The tablet computer 610 may include a processor (not depicted), memory device (not depicted), communication interface (not depicted), peripheral device interface (not depicted), display device interface (not depicted), storage device (not depicted), and touch screen display 624, which may possess characteristics of the processor 518, memory device 520, communication interface 522, peripheral device interface 512, display device interface 514, storage device 516, and display device 524, respectively, as described above with reference to FIG. 5. The touch screen display 624 may receive user input using technology such as, for example, resistive sensing technology, capacitive sensing technology, optical sensing technology, or any other appropriate touch-sensing technology.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features are described above with reference to the example architecture 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-6 may be used alone without the other features and elements or in various combinations with or without other features and elements. Sub-elements and/or sub-steps of the methods described above with reference to FIGS. 1-6 may be performed in any arbitrary order (including concurrently), in any combination or sub-combination.

It should be understood that many variations are possible based on the disclosure herein. Although features and elements are described above in particular combinations, each feature or element may be used alone without the other features and elements or in various combinations with or without other features and elements.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system for event marketing measurement, the system comprising:
a data input module configured to receive information about an event from visitors of the event; and
an enterprise system including:
a communication interface configured to receive the information from the data input module;
a memory device to configured to store the information received by the communication interface; and
a processor to derive metrics from the stored information associated with the event, the metrics including an opportunity score, a brand score, a relationship impact score, and an experience score, the metrics being combined to determine an overall event score.

2. The system of claim 1, further comprising the communication interface outputting the overall event score via email to a distribution list.

3. The system of claim 1, further comprising the communication interface receiving overall event scores from other events and the processor comparing the overall event score with the received overall event scores of other events.

4. The system of claim 1, wherein the overall event score is a combination using equal weighting of the metrics.

5. The system of claim 1, wherein the overall event score is a combination using unequal weighting of the metrics.

6. The system of claim 1, wherein the received information received by the data input module includes at least a plurality of on-site personal intercept surveys, online surveys, inquiry/lead analysis.

7. The system of claim 1, wherein the metrics are derived individually using an average score on the questions determined to be identified with one or more of the metrics.

8. The system of claim 7, wherein the metrics are derived based on revenue potential.

9. A method for performing event marketing measurement, the method comprising:
receiving, at a data input module, information about an event from visitors of the event;
receiving, via a communication interface of an enterprise system, the information from the data input module;
storing, via a memory device of the enterprise system, the information received by the communication interface; and
deriving, using a processor of the enterprise system, metrics from the stored information associated with the event, the metrics including an opportunity score, a brand score, a relationship impact score, and an experience score, the metrics being combined to determine an overall event score.

10. The method of claim 9, further comprising outputting, via a communications interface of the enterprise system, the overall event score via email to a distribution list.

11. The method of claim 9, further comprising receiving, via a communications interface of the enterprise system, overall event scores from other events and comparing, using the processor of the enterprise system, the overall event score with the received overall event scores of other events.

12. The method of claim 9, wherein the overall event score is a combination using equal weighting of the metrics.

13. The method of claim 9, wherein the overall event score is a combination using unequal weighting of the metrics.

14. The method of claim 9, wherein the information received by the data input module includes at least a plurality of on-site personal intercept surveys, online surveys, inquiry/lead analysis.

15. The method of claim 9, wherein the metrics are derived individually using an average score on the questions determined to be identified with one or more of the metrics.

16. The method of claim 15, wherein the metrics are derived based on revenue potential.

17. The method of claim 9, wherein the opportunity score measures the potential sales opportunities for products marketed at the event.

18. The method of claim 9, wherein the brand score measures the impact of the event on a brand.

19. The method of claim 9, wherein the relationship impact score measures the quality of relationships as a result of the event.

20. The method of claim 9, wherein the experience score measures the quality of the experience based on the event.
